(19) United States
(12) Patent Application Publication
(10) Pub. No.: US 2003/0230201 A1
(43) Pub. Date: Dec. 18, 2003

(54) Vacuum food container

(76) Inventor: Iris G. Zhao, Philadelphia, PA (US)

Correspondence Address: Iris G. Zhao, #C-20, 1925 Chestnut Street, Philadelphia, PA, 19103, US

(21) Appl. No.: 10/171,783

(22) Filed: Jun. 17, 2002

(51) Int. Cl. A01J 11/04; A23B 4/00

(52) U.S. Cl. 99/467; 99/472

(57) ABSTRACT

A novel finger vacuum apparatus comprises a syringe and a sealable food container. One best mode combines a syringe, a food container having a hole-like opening, and a fluid exchange connecter. The pulling of the plunge in a syringe directly makes a vacuum. Hypodermic injection adapter and flexible flap can be used to open and close a hole-like opening on a food container. This vacuum is useful for nursing mother, lightweight traveling, lunch box, energy saving, e.g., vacuum cooking under 100° C. after energy supply has been stopped, green house storage against aerobic bacteria, pressured aroma development, and for school as a education tool.

### FIELD OF THE INVENTION

The present invention relates to a syringe vacuumed food container, particularly suitable for lightweight travel.

### BACKGROUND OF THE INVENTION

The prior art is prolific in patents that teach how to make vacuum in a rigid or deformable food container. U.S. patent (U.S. Pat. No 5,979,688, 1999) issued to Stodd disclosed a “Vacuum container with reclosable sealing closure . . . ” requires an elastic adhesive sealant extending into a vent button and including an outwardly projecting peripheral bottom flange, which has main physical feature different from the disclosure. U.S. patent issued to Yang (U.S. Pat. No. 5,449,079, 1995) comprises a sealing cap body, a bottom cap, an annular gasket, and an air valve, which the present application does not use. Since the present art does not use the inside wall of food container as a vacuum tube, this container is free to be any shape. The “Vacuum food container device” U.S. Pat. No. 5,405,038 issued to Chuang comprises an umbrella-shaped silicon piece, which can bend upwards to allow air drawn out by a pump, but is restricted from bending downwards, which teaches away from the present syringe vacuum. So far, no one has combined syringe and liquid exchange connector with a sealable food container even though their combination offers significant advantage. Thus, the disclosure brings up an unexpected result to skilled in distance fields and the vacuum apparatus made thereof holds unobvious superior to conventional ones. In addition, the present vacuum container system is the simplest to practice and most cost save with improved flavor and nutrient retention.

The most pertinent pates to the present invention is believed to be U.S. Pat. No. 4,975,028, issued to Schultz, Dec. 4, 1990 providing a two-stroke reciprocating -piston pump having a vacuum cup, and two control valves. The piston-check-valve and the flexible check valve alternate between open and close during evacuation of a rigid food container with one valve being open when the other is closed. In contrast, the syringe apparatus from present invention comprises only one operation step and one connector without direction alternation. Therefore, consumer can make a vacuum in own fingertips and most containers can easily obtain vacuum benefits. In addition, the disclosed vacuum device can inject an aroma into a sealable food, but prior art cannot. Thus, the present invention holds unobviousness, effectiveness and simplicity over prior records.

### DESCRIPTION OF THE DRAWINGS/EMBODIMENT

DRAWING 1. Showing syringe vacuum (1 cc-150 cc by volume)—Finger Vacuum: The plunger will be pulled to create a vacuum. The barrel holds the plunger airtight during the pulling.

The taper tip of the syringe can be catheter-like to be inserted into a bag for drawing air out of the bag.

DRAWING 2. Showing the operation of fluid injection connector

FIG. 1. Up graph is the up view when all 3 lumina (hollow cylinder cavities) of the connector are aligned in same axes to open the adaptor.

Low graph is the up view when the ball is rotated away from the central lumen axes to close the adaptor.

FIG. 2. Up graph is the lateral view when the adaptor is opened.

Low graph is the lateral view when the adapter is closed.

FIG. 3. Showing how to operate a rubber tuber and click. Putting on a clip blocks the tube. Loosing and taking off the clip will open the tube.

DRAWING 3. Showing the operation of intravenous injection system (syringe and adaptor)

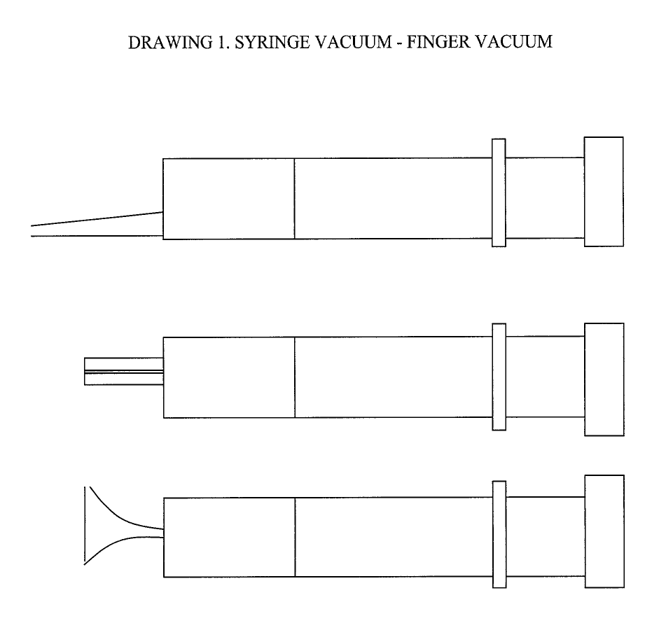

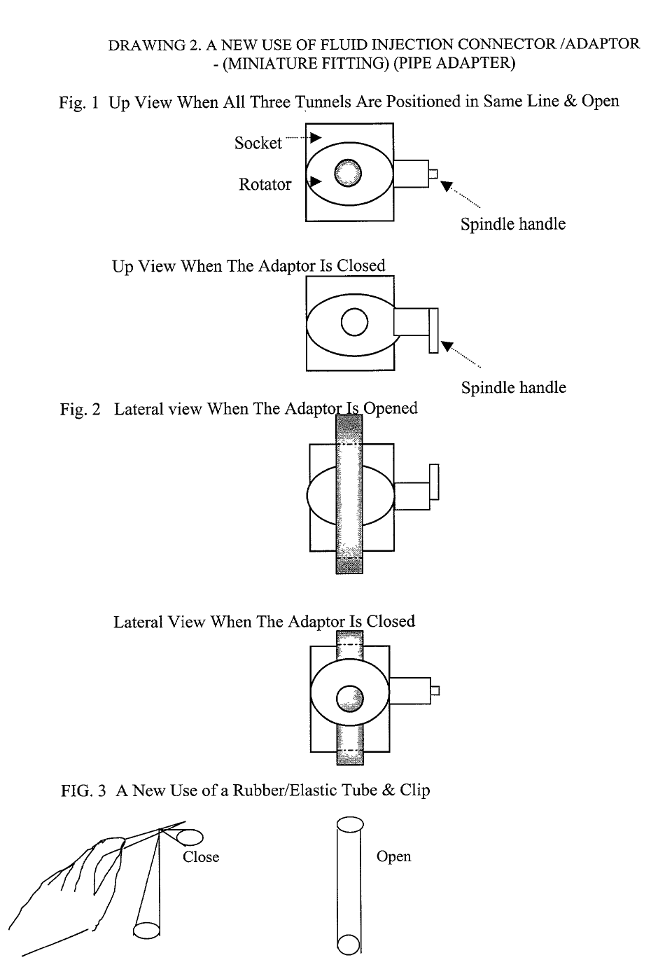

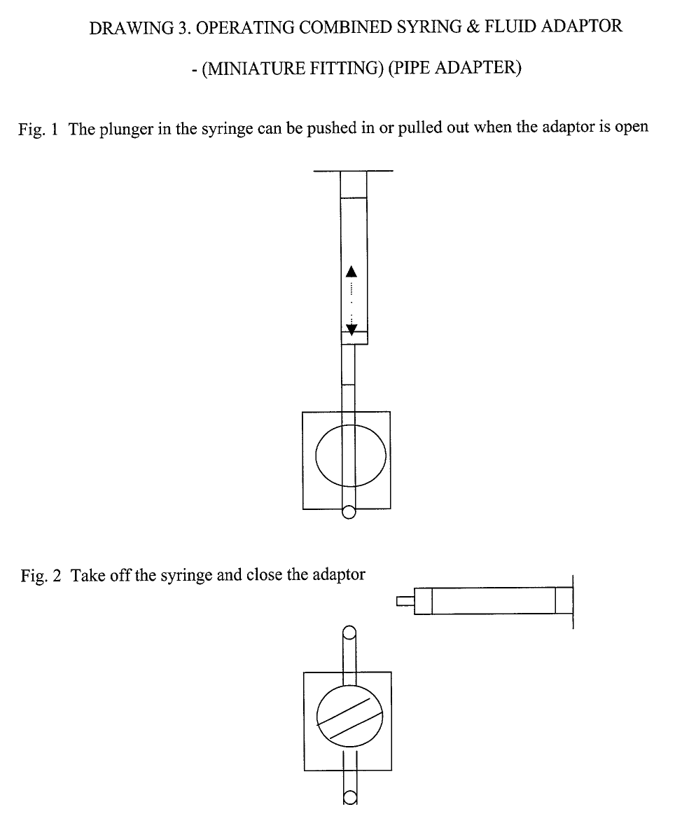

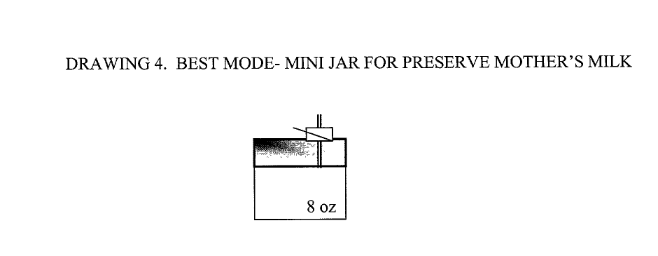

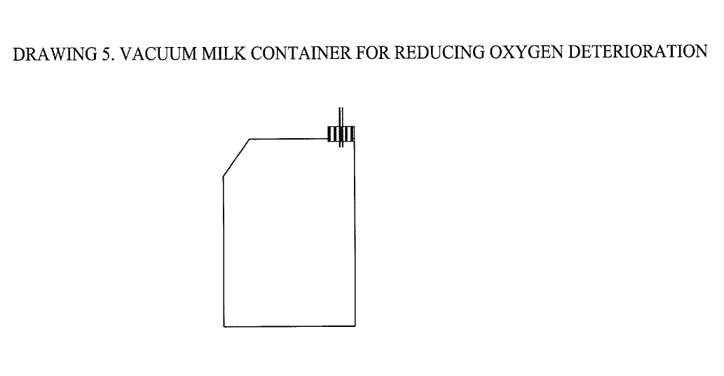

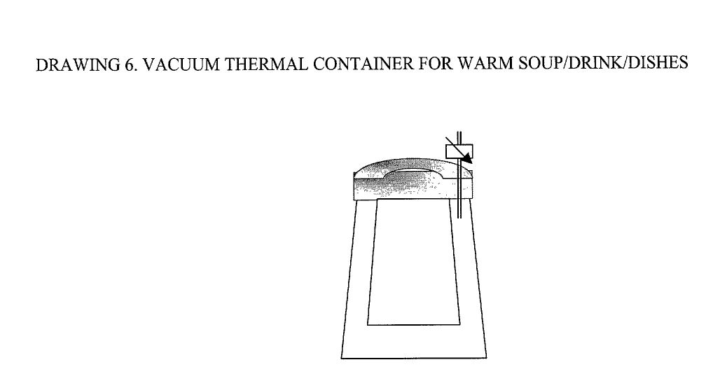

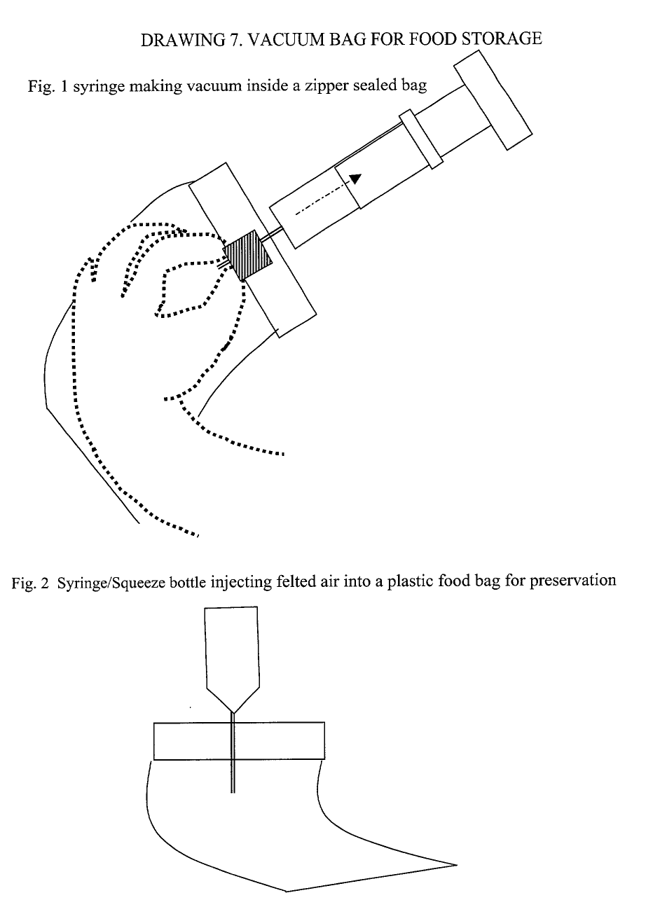

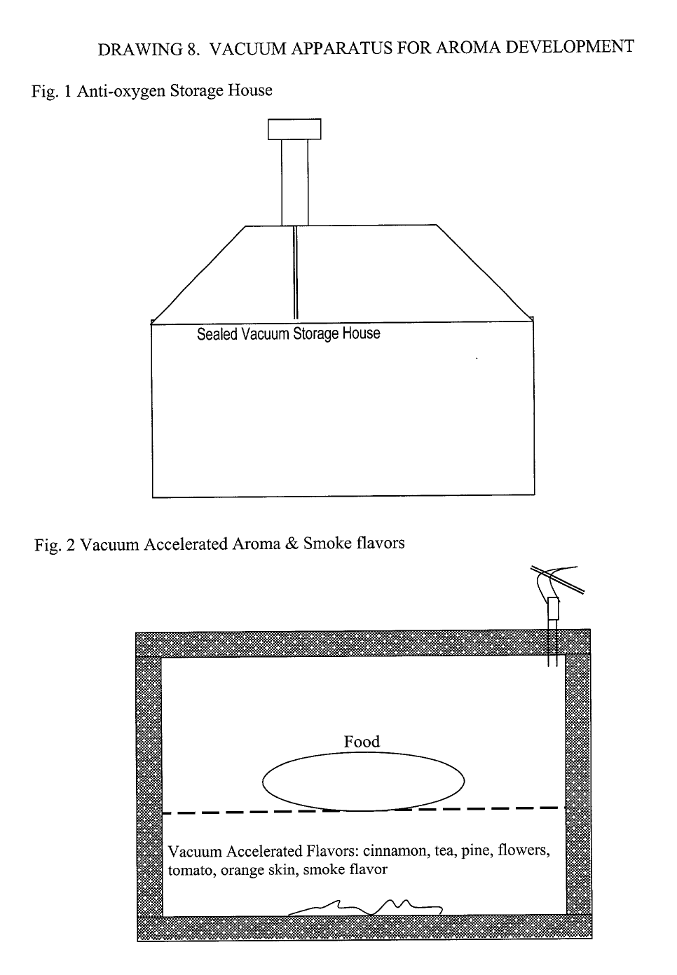

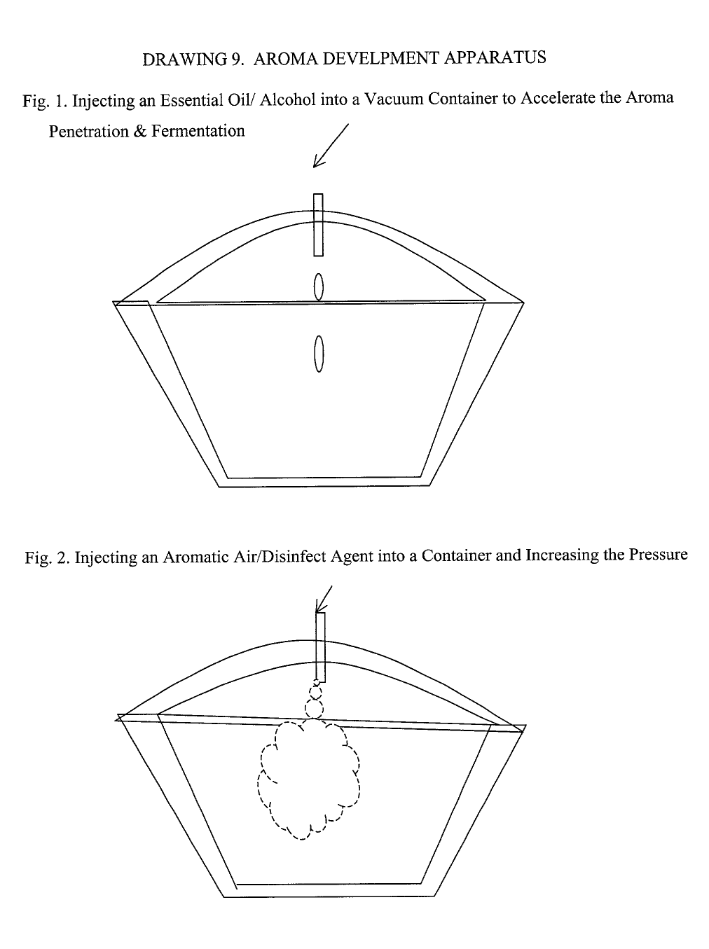

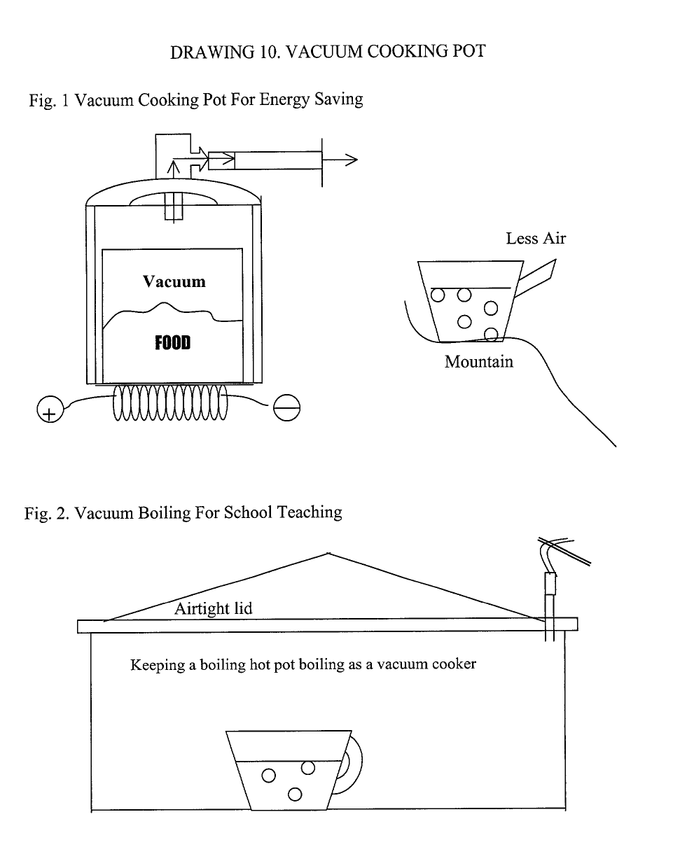

FIG. 1. The plunger in the syringe can be pushed in and pulled out when the adaptor is open.

FIG. 2. Take off the syringe and close the adaptor so that the created environment within the container can be maintained.

DRAWING 4. Best embodiment—Mini jar for mother's milk

Vacuum keeping oxygen-sensitive material fresh. Keep fruit, salads and snacks crisp and fresh.

Make a hole on the 8-ounce food jar so that the air within the jar can be drawn out to form a vacuum and thereafter the adapter will close the hole.

DRAWING 5. Vacuum a regular milk container to increase the preservation time

Milk can easily be spoiled once the lid of the milk bottle is opened because a lot of air getting into it.

Pin a tiny hole on the lid so that the air within the container can be drawn out.

DRAWING 6. Vacuum thermal container for warm soup/drink/dishes

DRAWING 7. Vacuum bag for food preservation

FIG. 1 Syringe Making Vacuum inside a Sealed Bag

The syringe has a tapered tip, which is inserted into a sealed bag and will be pulled out once the desirable vacuum is reached. During the sealing process, one hand is pulling out the tip of the syringe and another hand is sealing the adhesion zone of the bag. The catheter-like protrude should be longer (approximately 3 cm to 9 cm) than needles (approximately 0.5-5 cm). The caliber of such catheter is about 0.1 mm-1 mm. Since this catheter-like protrude has no sharp tip, by nature, it is safer than needles.

FIG. 2 A squeeze bottle can inject an aromatic air into a plastic sandwich bag with increased pressure, which accelerates the aroma develop. Consumers can choose a nontoxic smoke flavor and add it into the food bag.

DRAWING 8. Anti-oxygen storage house

FIG. 1 Vacuum House for food storage

FIG. 2 Adding a food aroma into the container enhances healthy food reservation and flavor.

Adding inert air bubbles into the wall of the container also helps the reservation. The food box can also be made of aromatic wood/herb/starch/glue.

DRAWING 9. Vacuum apparatus for aroma development

FIG. 1. Showing a laboratory-like preservative container. Unlike conventional laboratory preservation container using an oilment to seal the edge between a container and its lid, and using chemicals to absorb CO2/moisture, the present container uses syringe created vacuum to help the lid closing and material preservation.

FIG. 2. Injecting an aromatic air and increasing the penetration pressure of flavors

Adding a food aroma into the container enhances healthy food reservation and flavor. Adding inert air bubbles into the wall of the container also helps the reservation.

DRAWING 10. Vacuum Cooking Pot

FIG. 1 Showing a combination of electric hot pot with an adjustable opening. Pulling up the syringe plunge & closing the adaptor will induce a vacuum so that after a regular cooking, a vacuum boiling will continue even when the temperature is under conventional boiling point (<100° C.).

FIG. 2. Vacuum cooking apparatus as a school teaching tool.

Showing the relation between atmosphere and boiling point in a class. Water usually does not boil below 100° C. However, when there is less air, e.g., on a mountain, the boiling point for water is below 100° C. Put a boiling hot pot into the sealed container and draw air out of the container to form a vacuum so that the hot pot will continually boil. Vacuum cooking is relatively safer than high-pressured boiler.

### DETAILED DESCRIPTION OF THE PRESENT INVENTION

To overcome individual limitation inherited from prior vacuum devices, the disclosure provides a syringe apparatus. The characteristics of the invention are the novel combination of opposite features in diverse fields. In healthcare field, syringe and its adaptor are supposed to inject liquid or draw blood but not air. A sealable container is not supposed to have an opening. Allowing a sealable food container having a hole opens an adjustable channel for multiple usages, which can be controlled by an injection adapter. Differentiated form previous high presser valve and high temperature melted plug, syringe and liquid exchange adapter from the disclosure ease the vacuum making and is much safer.

Many strong bacteria are vulnerable to gas and electrical factors than refrigerator. Obligate aerobes, e.g., pseudomonas aeruginosa grows best in the 20% oxygen of room air but not at all under anaerobic conditions (Levinson & Jawetz, Medical Microbiology & Immunology, p 66-122, Appleton & Lange, 1994). Anthracis, cereus, diphtheria, asteroids, monocytogenes, pertussis, pneumophia, tuberculosis, nocardia, brucella, and tularine are also aerobic. In contrast to complicated vacuum devices in prior records, this multi-function food container is simple and effective. Syringe and adaptor are widely used by professionals in biologic field for transferring liquids into and out of human and animal tissue and vessels. A standard hypodermic injection system includes a syringe (airtight tube, plunger), a “ [symbol] ” shaped adaptor as an opening and closing switch (e.g., “BD MS01-T screw type all-purpose one-way #513136, #513137), and a needle. When the plunger is pulled back, a vacuum is created to draw liquid from a vessel. Medical injection system has many improved models, e.g., Gettig et al. disclosed an improved hypodermic adaptor connector system enabling syringes and T-shaped slots to selectively interface with various intravenous ports for injecting medication subcutaneously (U.S. Pat. No. 5,609,584, 1997). However, there has never been any suggestion to operate syringe and injection adaptor as a vacuum food apparatus because these fields are too far apart in spite of significant advantage.

In food industry fields, vacuum is used for 1) vacuum cooking and 2) preservation, whereas pressure is used for 3) accelerating aromatic penetration. In past, these three operations have to be carried out by three devices. For example, current development of French vacuum cooking technique provides tender and delicious meat through vacuum plastic bags. Recent vacuum machine on market for food preservation in plastic rolls uses electric suction, which has different operation manner. Perry (U.S. Pat. No. 5,520,101, 1996) teaches a mechanical gas flushing system including a piston portion. The piston has a nonstick surface to contact and detach the food in the container, which differs from the present food container. U.S. Pat. No. 5,669,528, “Vacuum storage and dispensing container” issued to Romero et al, Sep. 23, 1997, provides a container for extending the shelf life of roast coffee in retailers. However, it relies on the tightness between whole movable lid and the inner wall of the container, which teaches away from the disclosure. U.S. Pat. No. 5,443,653, “Press-on, pry-off closure for microwavable vacuum sealed container” provides a vacuum food packages by a sap rib for controlling the seal, which also teaches away form present art.

The present invention is a simple apparatus providing multi-functions. The term “multi-functions” as used herein denotes green (vacuum) storage, temperature preservation, vacuum cooking, and aroma development. Such food container includes:

1. a sealable nontoxic food container having an opening, and

2. a syringe as a lightest vacuum maker and/or accelerated aroma maker.

A liquid exchange connector may connect such syringe and opening for airway control.

The syringe is connected to above opening to draw air as vacuum making device, or to inject a high pressed aroma/disinfective agent to create a desirable condition. Aroma, alcohol, vinegar, seasoning, and lactic acid intend to evaporate and enhance the flavor and to inhibit germs by nature. Vacuum accelerates the evaporation of aroma and resists aerobic microorganisms.

The opening can be a hole, triangle, slit, square, adhesion seal or any shape. Preferably, the opening is a hole. The caliber (diameter, lumen) of above hole ranges from about 0.1 mm-5 mm, preferably from 0.1-1 mm. When the syringe draws a fluid from inside of the container through the connector, a vacuum is created. A plug may block the hole and keep the vacuum, but a connector is safer and easier than a plug. Some drug container has a rub lid so that a sharp needle can be inserted and the rub will hold the needle tight. However, needles must be avoided in the market. Plus, the caliber of needles is too narrow to make a quick and big transition. Thus, a liquid exchange connector is directly connecting the syringe and the hole to control the opening and closing. The connector is selected from the group consisting of a rigid intravenous injection “ [symbol] ” shape adaptor with a handle, an elastic tube with a clip, a pressure sensitive flexible dome, a pressure sensitive flexible flap, and a water pipe switch.

The intravenous injection “ [symbol] ” shape adaptor containing:

a) a main body, residing a central socket-like hollow cavity in the center with two opposite lumina arms extended to the opposite outside surface of such main body, and

b) a rotary ball having a handle. The rotator fits air-tightly into the hollow cavity in the main body.

The ball also has a central canal-like lumen, which can be rotated by the handle to be aligned with above two lumina into an axis for transmitting a fluid between the food container and the syringe. When the lumen on the ball rotator is rotated away from other lumina, the adaptor is closed so that no fluid can pass.

The elastic rubber or silicon tube has one end connected to the opening of sealable food container and another end connected to a syringe. When a clip closes the lumen of the elastic tube, a desirable condition is maintained inside the multi-function food container. When the clip is loosed, the elastic tube lumen is re-opened and a fluid can be transmitted. Fluid consists of air and liquid. The point of the disclosure is to operate a liquid switch as an air switch.

The disclosure provides a novel use of a syringe as a vacuum suction for a food bag. The catheter-like taped tip of the syringe is longer (approximately 3 cm-9 cm) than needles (approximately 0.5-6 cm) for inserting into a sandwich bag. The caliber of such protrude is about 0.1 mm-2 mm. The syringe can be inserted into the recess of the intravenous injection adaptor, or directly to the hole of the container. Differing from typical syringe use of blood drawing and solution injection, the syringe from the present art draws air out of a food container as well as injects aroma and high-pressured gas into a container.

The method of making this multi-functional food container, comprising:

a) making a smooth opening on a sealable food container, preferable a hole-like opening ranging from 0.1 mm to 3 mm by diameter. Particularly a hole ranging from 0.1-2 mm so that a fluid exchange can be easily performed without too much resistance.

b) inserting a fluid exchange connector into such hole to open and close the hole,

c) inserting a syringe into such fluid exchange connector to make a fluid transmission.

This syringe transmits and creates a desirable environment through the fluid exchange connector.

Further differentiated from previous container, this container has multiple functions. Besides drawing a fluid out of a container to create a vacuum, a fluid can be injected into a sealable food container to create an aroma and special gas replacement. The fluid can be either air or liquid, e.g., solution, alcohol, oil, aroma agent, disinfect agent, high-pressure gas. Essential oil evaporates faster in a vacuum container than conventional containers.

Previously, people put a cooked hot pot into a big sealed container to keep it warm, which has a disadvantage because once the hot pot is put into the container it will stop boiling. This vacuum container enables the food continually boiling under conventional boil point (100° C.). It is an amazing game for kids as a scientific experiment. Plus, such vacuum food container reduces cool and hot temperature loss during storage and save energy. Therefore, the food inside the container will be fresh and tender for a longer period. Preservation means cool/hot temperature, moisture/dryness, disinfection, and smoke/aroma. The container can further include gas bubbles in walls to reduce heat conductivity and weight for lunch box. In contrast to conventional plastic container becoming softened by heat, the air in the wall of the container will extend to hold the shape. In addition, the food container can further comprise an element to be released under heating and touching. For example, a trace element released in a speed equivalent to “Recommended Daily Allowance”, e.g., selenium 44-108 μg, zinc 5-15 mg, magnesium 200-700 mg per day through a gradual resolution from the inner surface of the container during cooking and preservation.

The food container is made of a mixture selected from plastic, glass, pottery/clay/sand, alloy, steel, oil, egg, inert air, glue/starch, aromatic element/seasoning, e.g., paper, clover, cinnamon, aniseed, bay leaf, food preservatives, and plant fiber, e.g., pulverized whole wood and herb slurry. Sand and clay have long reservation period without annoying smell. Egg helps glueing materials together. Oil smoothes and seals the surface. Realgar (red orpiment) is believed to have some sterilization effect. Differed from refrigerator, small amount of aroma resists multiple microorganisms while improving flavor.

There are three ways to make an aromatic food container. One method comprises 1) reducing the size of a nontoxic plant to a puree-like slurry, 2) adding a liquid, starch or glue, and aromatic material to form a mixture, 3) whipping the mixture to increase the viscosity, 4) pouring the slurry into a mold, 5) pressing and squeezing moisture out of the slurry to form a container. Another method is painting vicious aromatic solution on the inner wall of a food container so that heat vulnerable aroma element will not be destroyed during high temperature molding. The third way is providing a supporting network frame for natural plant fiber and heat vulnerable aromatic material, comprising: 1) setting a container-shaped network frame made of a hard material, e.g., stainless steel, 2) dipping such frame into viscous fibrous slurry, and 3) dry harden the container under high-pressured. After several turns, such frame will pick up enough thickness and strength. The cool process is particularly suitable for aromatic food container made of heat vulnerable natural aromatic component. Aromatic seasoning, leaf, wood, grass, and herb are excellent material for this food container. Bamboo, pine, cattail, and lotus leaf provide both fiber and aroma. Toxin indicator, e.g., silver, and antibody to E. coli and salmonella can be added to the inner wall of the container. Potato leaf and tomato are believed benefit bother purposes. Flower and tea are characterized by both aroma and fibers. Disinfection agents, e.g., SO₂, CL-, lactic acid, vinegar, can be added. Moreover, current research believes hydrogen positron can penetrate bacteria wall and kill the bacteria. Thus it is believable that the surface of the container can be hydrogenised or magnetized for sterilization.

Above described embodiments are merely illustrative of the principles of the invention. Modification can be made without departing from the scope of the invention. It is clear that the scope of the present invention should be interpreted solely on the bases of the following claims, as such claims are read in the light of the entire disclosure.

What is claimed is:

1. An apparatus for creating and keeping a desirable condition in a container, comprising:
a) a sealable food container having an opening, and
b) a syringe having a tip being connected to said opening to pull air out of said sealable food container, and thereafter the opening being sealed once a desirable condition has been reached.

2. An apparatus for creating and keeping a desirable condition in a container comprising:
a) a sealed container having a hole-like opening ranging from 0.1 mm to 3 mm by mean diameter,
b) an adjustable fluid exchanging connecter, connecting said hole to a syringe, wherein when said fluid connector is open, the air way of said sealable food container is open whereas when said fluid connector is closed the air way of the sealable food container is sealed, and
c) a 1 cc-100 cc volume syringe pulling air out of said sealed container through said adjustable fluid exchanging connector, and thereafter said fluid exchanging connector being closed once a desirable condition has been reached.

3. The apparatus for creating and keeping a desirable condition in a container according to claim 1 wherein said syringe comprising a movable plunger and a cylinder-like barrel holding said movable plunger air-tight, wherein one end of said cylinder-like barrel having a catheter-like opening, and another end being full open suitable for said movable plunger to move, wherein when said plunger being pulled toward said full opening end, a vacuum being created within the sealed space between the button of said plunger and the inner wall of said cylinder-like barrel.

4. The apparatus for creating and keeping a desirable condition in a container according to claim 1 wherein said fluid connector being selected from the group consisting of a rigid adapter with a rotating spindle, an elastic tube with a clip, a flaxible flap, a flexible dome, and a rigid water pipe switch with a rotary handle.

5. The apparatus for creating and keeping a desirable condition in a container according to claim 1, wherein said rigid adapter with a spindle handle is a rigid rotary adapter, comprising:
a) a main body, having a central socket-like hollow cavity with two canal-like lumen arms extended to two opposites outside surfaces of said main body, and
b) a ball-like rotator, fitting air-tightly into said central socket-like hollow cavity, wherein said ball-like rotator having a central canal-like lumen and a rotary handle,
wherein all said three lumina have same sized diameter and each said canal occupying approximately ⅕-⅗ by length of said main body,
wherein when said three lumina aligned in same axis, said rotary adapter being opened and a fluid being transmitted, whereas when the lumen on the ball rotator being rotated away from said axis, the rotary adaptor being closed so that no fluid can pass.

6. The apparatus for creating and keeping a desirable condition in a container according to claim 1, wherein one end of said elastic tube being connected to the opening of a food container, and another end of the elastic tube being connected to a syringe,
wherein when said clip opening the lumen of said elastic tube, a fluid being transmitted and when the clip closing the lumen of said elastic tube, a desirable condition being remained inside of said container.

7. The apparatus for creating and keeping a desirable condition in a container according to claim 1, wherein said container is made by a material essentially consisting of plastic, low heat conductivity gas, pottery, sand, glass, steel, silver, alloy, silicon, plant fiber, aromatic agent, food preservative, disinfect agent, starch, glue, egg, and network frame.

8. A method of making an apparatus for creating and keeping a desirable condition in a container, comprising:
a) making an opening on a sealed food container,
b) connecting a blockable connector to said opening, wherein said blockable connector being selected from the group consisting of a rigid adapter having a rotary spindle, a rigid water pipe switch, an elastic tube with a clip, a flexible dome, and a flexible flap,
c) connecting a syringe to said blockable connector, wherein said syringe pulling and sucking air out of said sealed food container through the blockable connector, and
d) blocking said blockable connector while pulling off said syringe once a desirable condition has been reached.

9. The method of making an apparatus for creating and keeping a desirable condition in a container according to claim 1, comprising:
a) inserting a syringe tip into a sealable food bag,
b) pulling air out of said sealable food bag through said syringe, and
c) sealing said food bag while pulling off said syringe once a desirable condition has been reached.

10. The method of making an apparatus for creating and keeping a desirable condition in a container according to claim 1, comprising adding a material consisting of a plastic, low heat conductivity gas, sand, metal, silicon, plant fiber, aromatic agent, food preservative, disinfect agent, starch, glue, egg, and network frame.
